(19) United States
(12) Patent Application Publication
(10) Pub. No.: US 2011/0273918 A1
(43) Pub. Date: Nov. 10, 2011

(54) POWER DEVICE

(75) Inventor: HENG-CHEN KUO, Tu-Cheng (TW)

(73) Assignee: HON HAI PRECISION INDUSTRY CO., LTD., Tu-Cheng (TW)

(21) Appl. No.: 12/794,799

(22) Filed: Jun. 7, 2010

(30) Foreign Application Priority Data
May 10, 2010 (TW) 99114747

(51) Int. Cl. H02M 7/06

(52) U.S. Cl. 363/126

(57) ABSTRACT

A power device includes two groups of diodes, a step-down circuit, and a capacitor. Each group of diodes includes a first diode and a second diode. An anode of the first diode is connected to a cathode of the second diode, a node between the first and second diode is connected to one of live lines and neutral lines of at least one alternating current source. The step-down circuit includes a first input terminal, a second input terminal, a first output terminal, and a second output terminal. The first and second input terminals are respectively connected to cathodes of the first diodes and anodes of the second diodes, the first and second output terminals are respectively connected to a power terminal and a ground terminal of a load. Two terminals of the capacitor are respectively connected to the first and second input terminals of the step-down circuit.

### BACKGROUND

1. Technical Field

The present disclosure relates to power devices, and more particularly to a power device for converting alternating current (AC) to direct current (DC).

2. Description of Related Art

Rectifiers are used to convert or rectify AC to DC. Rectifiers include interfaces to be connected to live lines and a neutral line of a single AC source. If there are any mistakes in making the connections or if there are problems with the source, such as phase voltage unbalance, power output by the power device may be unstable and unreliable.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a circuit diagram of an embodiment of a power device.

FIG. 2 is a block diagram of the power device of FIG. 1 connected to a plurality of alternating current sources and a load.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

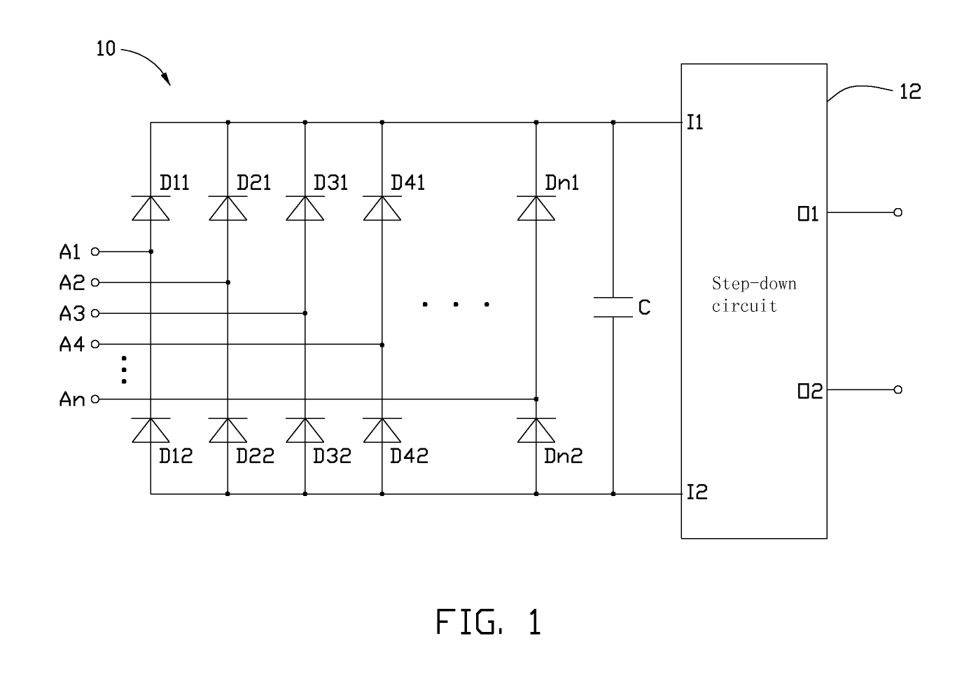

Referring to FIG. 1, an exemplary embodiment of a power device 10 includes N groups of diodes, a capacitor C, and a step-down circuit 12, wherein the parameter N is an integer not smaller than two.

Each group of diodes includes a first diode (D11, D21, D31, D41, . . . or Dn1) and a second diode (D12, D22, D32, D42, . . . or Dn2). The step-down circuit 12 includes a first input terminal I1, a second input terminal I2, a first output terminal O1, and a second output terminal O2. An anode of each first diode is connected to a cathode of a corresponding second diode, a cathode of each first diode is connected to the first input terminal I1 of the step-down circuit 12, an anode of each second diode is connected to the second output terminal O2 of the step-down circuit 12. Two terminals of the capacitor C are respectively connected to the first and second input terminals I1 and I2 of the step-down circuit 12. The step-down circuit 12 is well known to those of ordinary skill in the art, so details of the step-down circuit 12 are omitted here.

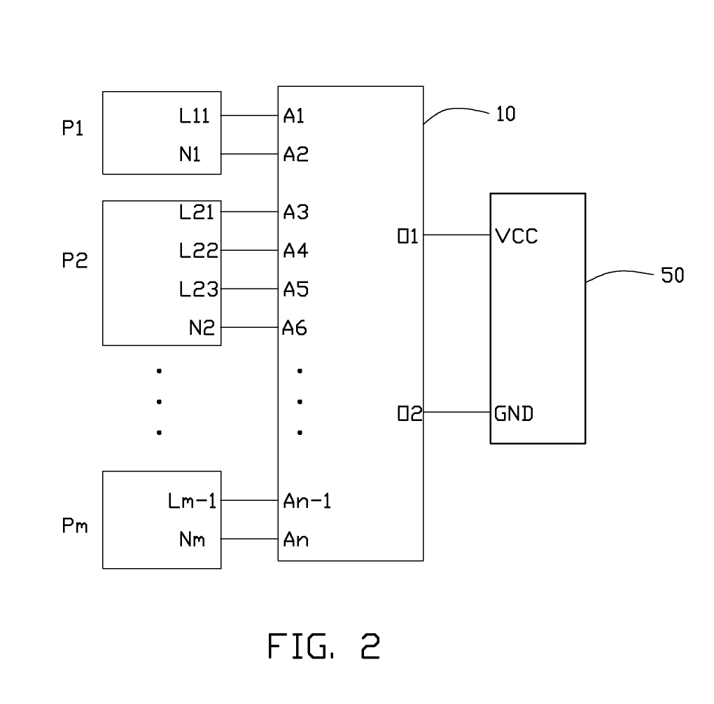

Referring to FIG. 2, in use, live lines L11, L21, L22, L23, . . . , Lm-1 and neutral lines N1, N2, . . . , Nm of several alternating current (AC) sources P1, P2, . . . , Pm are respectively connected to nodes A1-An between the first diodes D11, D12, . . . , Dn1 and the corresponding second diodes D12, D22, . . . , Dn2, wherein the parameters n and m are positive integers. The nodes Al-An function as interfaces for receiving power from the AC sources P1-Pm. Reverse breakdown voltages of each first diode and each second diode are both greater than a highest voltage output by the AC sources P1-Pm. The first and second output terminals O1 and O2 are respectively connected to a power terminal VCC and ground terminal GND of a load 50, wherein the AC sources P1 and Pm are both single-phase double-wire type AC sources, the AC source P2 is a three-phase four-wire type AC source.

Because reverse breakdown voltages of each first diode and each second diode are both greater than a highest voltage output by the AC sources P1-Pm, when one of the first diodes receiving the highest voltage is turned on, cathode voltages of the other first diodes are higher than corresponding anode voltages of themselves, so only the first diode receiving the highest voltage is turned on, and the other first diodes are all turned off. Highest voltage output by the AC sources P1-Pm is regulated by the first and second diodes receiving the highest voltage, then the highest voltage is filtered by the capacitor C to a direct current (DC) voltage and transmitted to the step-down circuit 12. The step-down circuit 12 receives the DC voltage and supplies an appropriate voltage to the load 50. When one of the AC source works abnormally, the diodes connected to the other AC sources keep regulating voltages output by the other AC sources, to make the step-down circuit 12 output steady DC voltage to the load 50, so as to ensure the load 50 to work well all the time.

In other embodiments, the amount of the first and second diodes may be changed according to need. When the AC source Pm is a three-phase four-wire AC source and the three phases are in balance, the neutral line of the AC source Pm could be idle.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A power device comprising:
at least two groups of diodes, wherein each group of diodes comprises a first diode and a second diode, an anode of the first diode is connected to a cathode of the corresponding second diode, a node between each first diode and the corresponding second diode is connected to one of live lines and neutral lines of at least one alternating current source;
a step-down circuit comprising a first input terminal, a second input terminal, a first output terminal, and a second output terminal, the first and second input terminals are respectively connected to cathodes of the first diodes and anodes of the second diodes, respectively, the first and second output terminals are respectively connected to a power terminal and a ground terminal of a load, respectively; and
a capacitor with two terminals respectively connected to the first and second input terminals of the step-down circuit.
